(19) United States
(12) Patent Application Publication
(10) Pub. No.: US 2007/0002727 A1
(43) Pub. Date: Jan. 4, 2007

(54) Combined sampling rate conversion and gain-controlled filtering

(75) Inventors: Jeroen Hubert Christoffel Jacobus Stessen, Eindhoven (NL); Johan Gerard Willem Maria Janssen, Santa Clara, CA (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., 5621 BA Eindhoven (NL)

(21) Appl. No.: 10/553,556

(22) PCT Filed: Apr. 22, 2004
(86) PCT No.: PCT/IB04/50490

§ 371 Date: Oct. 19, 2005

(30) Foreign Application Priority Data
Apr. 24, 2003 (EP) 03101140.6

(51) Int. Cl. H04J 11/00

(52) U.S. Cl. 370/210

(57) ABSTRACT

The invention relates to a method for sampling rate conversion. To solve the object of the invention to provide an efficient method for sampling rate conversion of a digital signal with an improvement of the signal quality, a method for combined sampling rate conversion and gain-controlled filtering of a digital signal is proposed, where an input signal is converted into a filtered output signal, comprising the steps of filtering the input signal with a first polyphase filter yielding a first intermediate signal, filtering the input signal with a second polyphase filter yielding a second intermediate signal, multiplying said second intermediate signal with a gain control signal yielding a third intermediate signal, and adding said third intermediate signal to said first intermediate signal yielding said output signal. The object of the invention is further solved by a device and a computer program product for combined sampling rate conversion and gain-controlled filtering of a digital signal.

The invention relates to a method for combined sampling rate conversion and gain-controlled filtering of a digital signal, where an input signal is converted into a filtered output signal, comprising the steps of filtering the input signal with a first polyphase filter yielding a first intermediate signal, filtering the input signal with a second polyphase filter yielding a second intermediate signal, multiplying said second intermediate signal with a gain control signal yielding a third intermediate signal, and adding said third intermediate signal to said first intermediate signal yielding said output signal. The invention further relates to a device and a computer program product for combined sampling rate conversion and gain-controlled filtering of a digital signal.

In a variety of application fields of digital signal processing, the conversion of signals having a first sampling rate into signals with a second smaller or larger sampling rate is required. For instance, in the field of television image processing, display of television signals that are represented in different display formats is an indispensable requirement, as e.g. occurring in Picture-In-Picture (PIP) or Picture-Out-of-Picture (POP) modes of a television set or in the context of displaying the Standard Definition (SD) format that is currently broadcast by most television stations on television sets that are designed to display the High Definition (HD) format.

A state-of-the art device for sampling rate conversion, namely for conversion of component (VGA) video to television, is disclosed in U.S. Pat. No. 6,281,873 B1. Scaling of an input video signal is performed with a polyphase filter that acts as a low-pass interpolation filter with a fixed cut-off frequency and a programmable delay. By changing the coefficients of the polyphase filter, an input video signal is time shifted by fractions of the pixel clock and concurrently low-pass filtered to reduce flicker in the output video signal.

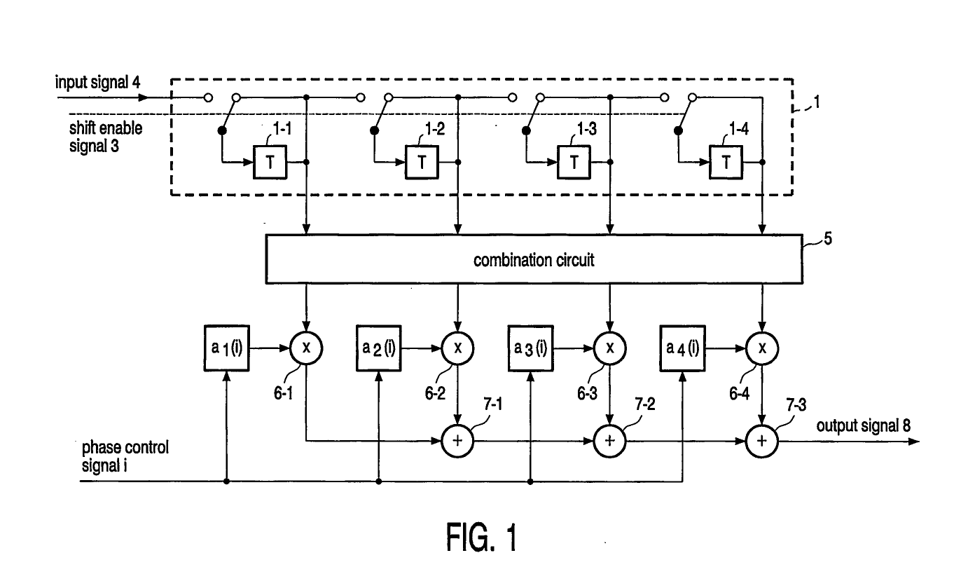

The basic structure of such a polyphase filter is depicted in FIG. 1. The polyphase filter possesses a multiplicity of registers 1-1 . . . 1-4 that form a shift register 1. The shift register 1 is controlled by a shift enable signal 3, that controls whether a new set of digital values is loaded into each register 1-1 . . . 1-4 or whether the digital values that are already contained in the registers are maintained. Said digital values are the consecutive digital values of a digital input signal 4.

The register output values of the registers 1-1 . . . 1-4 are further input to a combination circuit 5, which performs additive or subtractive combinations of the register output values yielding combination circuit output values. Each single combination circuit output value is further weighted with a filter coefficient a1(i) . . . a5(i) by means of multiplication instances 6-1 . . . 6-5 and added to the other weighted combination circuit output values by means of addition instances 7-1 . . . 7-4, finally yielding a digital value of the output signal 8. The filter coefficients a1(i) . . . a5(i) applied at each multiplication instance 6-1 . . . 6-5 are not fixed, but cyclically chosen from limited sets of filter coefficients {a1(1) . . . a1(N)} . . . {a5(1) . . . a5(N)} in response to a cyclic phase control signal i, where N denotes the number of different filter coefficients available at each multiplication instance 6-1 . . . 6-5 or the number of filtering steps per cycle.

In each filtering step, triggered by the phase control signal i and comprising the weighting of each combination circuit output value with filter coefficients a1(i) . . . a5(i) and the addition of the weighted combination circuit output values yielding one digital value of the output signal 8, the filter coefficients a1(i) . . . a5(i) define the impulse response of the polyphase filter. If the polyphase filter is desired to perform sampling rate conversion, the sets of filter coefficients {a1(1) . . . a1(N)} . . . {a5(1) . . . a5(N)} may be chosen so that in each filtering step, basically the same filter characteristic, but different filter phases are achieved. The different filter phases in the frequency domain transform back to different delays in the time domain, so that, depending on the chosen delays, re-sampling of the digital input signal at a sampling rate different from the input signal sampling rate is achieved. In each filtering step, the polyphase filter structure in FIG. 1 generates one output signal value. In order to achieve up-conversion, i.e. increase of the input signal sampling rate, the filter coefficients are chosen such that the delay between the output signal values is smaller than the inverse of the input signal sampling rate. Furthermore, depending on the shift enable signal 3, the registers 1-1 . . . 1-4 are not necessarily loaded with new input signal values in each filtering step, but store the input signal sampling values of the previous filtering step. For example, if a sampling rate up-conversion ratio of 5/4 is desired, four input signal values generate five output signal values, and in one out of five filtering steps of a cycle, the previous values are stored in the registers 1-1 . . . 1-4 instead of loading new input signal sampling values. The shift enable signal 3 triggers the operation of the shift register 1, whereas the phase control signal i ensures that the proper filter coefficients are applied at the multiplication instances 6-1 . . . 6-5 in each filtering step of a cycle.

Returning to the application field of up-conversion in image processing, it is a general drawback that up-conversion does not generate frequencies above the Nyquist limit of the input image. However, the viewer expects to see high frequency components in the enlarged spectrum of the up-converted image, and it is the lack of these high frequency components that results in perceived unsharpness of the up-converted image.

Derived from this application-specific example of image processing, it is thus the general object of this invention to provide an efficient method for sampling rate conversion of a digital signal with an improvement of the signal quality.

To solve the object of the invention, it is proposed that a method for combined sampling rate conversion and gain-controlled filtering of a digital signal, where an input signal is converted into a filtered output signal, comprises the steps of filtering the input signal with a first polyphase filter yielding a first intermediate signal, filtering the input signal with a second polyphase filter yielding a second intermediate signal, multiplying said second intermediate signal with a gain control signal yielding a third intermediate signal, and adding said third intermediate signal to said first intermediate signal yielding said output signal.

The use of first and second polyphase filters allows to implement both a sampling rate conversion and a two-fold filtering of the input digital signal. In the design of the first and second polyphase filters, which are defined by their filter coefficients, the filter phases of the first and second polyphase filter may be chosen equal to achieve the same sampling rate conversion, whereas the degree of freedom in fixing the filter characteristic of the first and second polyphase filter may be exploited to implement two substantially different filter functions. For example, if the first polyphase filter is implemented as low-pass filter for interpolation, the second filter can be designed to amplify a selected frequency range to improve signal quality. The gain control signal multiplied with the second intermediate signal controls the amplitude of the third intermediate signal and prevents the summed output signal from carrying more noise and from excessive clipping. Without gain control, the coefficients of both polyphase filters could be combined, and only one polyphase filter was necessary for both sampling rate conversion and filtering. However, control of the dynamics of the second filter then no longer was possible, and the dynamic range of the output signal would become uncontrollable and thus perceptually not attractive.

According to the present invention, it is advantageous that the first polyphase filter has a low-pass filter characteristic in the frequency domain. The first polyphase filter then operates as low-pass interpolation filter.

It is further advantageous that the second polyphase filter has a band-pass filter characteristic in the frequency domain. The band-pass filtering characteristic of the second polyphase filter amplifies only the high frequency components of the digital signal, so that in the summed output signal, a perceived lack of high frequency components as occurring in the first intermediate signal is compensated by addition of the third intermediate signal, i.e. the gain-controlled second intermediate signal. If the present invention is applied to image processing, the band-pass characteristic of the second polyphase filter allows to implement peaking methods or even non-linear Luminance Transition Improvement (LTI). However, these peaking and LTI methods amplify and even create new high frequency components and may cause the sharpened output signal to exceed its dedicated dynamic range, resulting in the output signal to carry more noise or to be excessively clipped. The dynamic range of the third intermediate signal is thus controlled by a gain control signal prior to the addition to the first intermediate signal.

According to the present invention, it is further advantageous that the gain control signal is derived from a signal that is generated by filtering the input signal with a third polyphase filter. The coefficients of the third polyphase filter may then be designed to achieve delays in accordance with the delays of the first and second polyphase filters, and to achieve a filter characteristic that implements functionality to derive a gain control value for each second intermediate signal value, e.g. an edge steepness detector, if the present invention is applied to image processing.

Gain control signals are preferably derived from polyphase filters that have a differentiation filter characteristic. In the context of image processing, such a differentiation filter implements for example an edge steepness detector.

According to the present invention, it is preferred that the filter coefficients for each multiplication tap of the polyphase filters are stored in look-up-tables and are cyclically read out in response to a phase signal.

An efficient implementation of the combined sampling rate conversion and gain-controlled filtering method according to the present invention is characterized in that the polyphase filters share the same shift register. This is of special relevance in the field of vertical television signal processing where each register represents an expensive line memory.

If the input signal is a video signal, it may be preferred that said input signal is transformed into the linear light domain by gamma correction before it is filtered with the polyphase filters and that said output signal is transformed back to the gamma domain by anti-gamma correction. Filtering in the linear light domain reduces aliasing. Furthermore, the performance of the second polyphase filter (LTI and peaking) is improved.

If the input signal is a video signal, it may also be preferred that gamma correction is performed for each output value of the registers within at least the first and second polyphase filter and that said output signal is transformed back to the gamma domain by anti-gamma correction. The register output values are then fed into multiple gamma correction circuits to achieve transformation from the gamma domain to the linear light domain prior to combination of the gamma-corrected register output values in the combination circuit 5. Filtering in the linear light domain reduces aliasing. Furthermore, the performance of the second polyphase filter (LTI and peaking) is improved. Gamma correction generally increases the word length of the video signal, so that applying the gamma correction before the registers implies that all registers must be made wider and thus more expensive. It is cheaper to apply gamma correction multiple times with gamma correction circuits located after the registers. This can only be achieved if cheap approximations of the gamma correction circuits are available. Another benefit of applying gamma correction behind the registers is that a third polyphase filter for edge detection can advantageously keep working in the gamma domain instead of working in the linear light domain. Anti-gamma correction is then performed once for the output signal.

A preferred application of the method according to the present invention in the field of television image processing is characterized in that said input signal is a Standard Definition Television (SDTV) signal, that said output signal is a High Definition Television (HDTV) signal, that said first polyphase filter performs spatial scaling, that said second polyphase filter performs peaking and/or LTI and that said third polyphase filter performs edge steepness detection. Thus SDTV signals can be viewed on HDTV-only high-resolution displays including both Cathode-Ray Tubes (CRT) and matrix displays.

According to a first embodiment of the present invention, a device for combined sampling rate conversion and gain-controlled filtering of a digital signal, where an input signal is converted into a filtered output signal, comprises a shift register comprising a multiplicity of registers that are jointly controlled by a shift enable signal for storing consecutive values of said digital signal, circuitry for multiplying the output of each register with filter coefficients of a first type and summing the products yielding a first intermediate signal, circuitry for multiplying the output of each register with filter coefficients of a second type and summing the products yielding a second intermediate signal, circuitry for multiplying the second intermediate signal with a gain control signal yielding a third intermediate signal, circuitry for adding the first and third intermediate signals yielding said output signal, and means to cyclically change the filter coefficients of the first and second type in response to a phase control signal. The filter coefficients of the first and second type can be independently adjusted to perform sampling rate conversion and two-fold filtering with different frequency domain filter characteristics, where the gain control signal prevents the third intermediate signal from exceeding a prescribed dynamic range. Both first and second polyphase filters share the same shift register, but use different filter coefficients.

According to the first embodiment of the present invention, it is preferred that the filter coefficients of the first type are chosen so that the filter DC gain is always one. Fixing the filter DC gain at one is the minimum requirement for a low-pass filter that may implement interpolation.

According to the first embodiment of the present invention, it is further preferred that the filter coefficients of the second type are chosen so that the filter DC gain approaches zero. Designing the second polyphase filter for zero DC gain implements a simple band-bass filter. In the context of image processing, such a band-pass filter is suitable for LTI and peaking of the input signal, where the resonant frequency of the second polyphase filter is constant with respect to the spectrum of the input signal.

According to the first embodiment of the present invention, it is further preferred that the device comprises circuitry for multiplying the output of each register with filter coefficients of a third type and summing the products yielding a signal that serves as a basis for said gain control signal.

The filter coefficients of the third type are designed to derive a signal that serves as a basis for the determination of gain control signal for each value of the weighted second intermediate signal, where the delays of the third polyphase may equal the delays of the first and second polyphase filters, and where the filter characteristic of the third polyphase filter implements the generation of the base signal serving as a basis for said gain control signal, e.g. an edge steepness detector in the application field of image processing. The gain control signal may then be derived from the signal as output by the third polyphase filter by forming absolute values, applying a non-linear circuit such as a look-up table to reduce the peaking of the steepest edges and by applying a coring function to reduce the peaking of noise signals.

According to a second embodiment of the present invention, a device for combined sampling rate conversion and gain-controlled filtering of a digital signal, where an input signal is converted into a filtered output signal, comprises a shift register comprising a multiplicity of registers that are jointly controlled by a shift enable signal for storing consecutive values of said digital signal, circuits for forming the differences between the outputs of adjacent registers, for multiplying these differences with filter coefficients of a first type and for summing the products and the output of at least one register yielding a first intermediate signal, circuitry for multiplying said differences with filter coefficients of a second type and for summing the products yielding a second intermediate signal, circuitry for multiplying the second intermediate signal with a gain control signal yielding a third intermediate signal, circuitry for adding the first and third intermediate signals yielding said output signal, and means to cyclically change the filter coefficients of the first and second type in response to a phase control signal. The filter coefficients of the first and second type can be independently adjusted to perform sampling rate conversion and two-fold filtering with different frequency domain filter characteristics, where the gain control signal prevents the third intermediate signal from exceeding a prescribed dynamic range. Both first and second polyphase filter share the same shift register, but use different filter coefficients. Forming the differences between the output of different registers prior to multiplication with the filter coefficients ensures that the DC gain is zero for the second polyphase filter. The first polyphase filter also operates with these differences, but additionally comprises a DC path, which is represented by the addition of the output of at least one register to the sum of the weighted differences of the register outputs. The second embodiment of the present invention thus comprises a first low-pass polyphase filter and a second band-pass polyphase filter.

According to the second embodiment of the present invention, it is further preferred that the device comprises circuitry for multiplying said differences with filter coefficients of a third type and for summing the products yielding a signal that serves as a basis for said gain control signal.

The filter coefficients of the third type are designed to derive a signal that serves as a basis for the determination of gain control signal for each value of the weighted second intermediate signal, where the delays of the third polyphase may equal the delays of the first and second polyphase filters, and where the filter characteristic of the third polyphase filter implements the generation of a signal that serves as a basis for said gain control signal, e.g. an edge steepness detector in the application field of image processing. The gain control signal may then be derived from the signal as output by the third polyphase filter by forming absolute values, applying a non-linear circuit such as a look-up table to reduce the peaking of the steepest edges and by applying a coring function to reduce the peaking of noise signals.

According to the first and second embodiments of the present invention, it is preferred that the devices further comprise look-up-tables for generating the filter coefficients of the first and second type in response to a phase control signal.

According to the first and second embodiments of the present invention, it may be preferred that, especially for application in image processing, the devices comprise one gamma correction circuit for applying gamma correction to said input signal and one anti-gamma correction circuit for applying anti-gamma correction to said output signal. The gamma correction circuit transforms the input signal from the gamma domain into the linear light domain. Filtering in the linear light domain reduces aliasing and improves the performance of the second polyphase filter (LTI and peaking). Anti-gamma correction is then performed for the output signal by the anti-gamma correction circuit.

According to the first and second embodiments of the present invention, it may be preferred that, especially for application in image processing, the devices comprise multiple gamma correction circuits for applying gamma correction to the outputs of said registers, and one anti-gamma correction circuit for applying anti-gamma correction to said output signal. The register outputs are fed into gamma correction circuits to achieve transformation from the gamma domain to the linear light domain. Filtering in the linear light domain reduces aliasing. Furthermore, the performance of the second polyphase filter (LTI and peaking) is improved. Gamma correction generally increases the word length of the video signal, so that applying the gamma correction before the registers implies that all registers must be made wider and thus more expensive. It is cheaper to apply gamma correction multiple times with gamma correction circuits located after the registers. This can only be achieved if cheap approximations of the gamma correction circuits are available. Another benefit of applying gamma correction behind the registers is that a third polyphase filter for edge detection can advantageously keep working in the gamma domain instead of working in the linear light domain. Anti-gamma correction is then performed for the output signal. The anti-gamma correction circuit must implement an exact inverse function of the prior gamma correction circuit, even if that gamma correction circuit is only an approximation. Since anti-gamma correction is applied only once, it is permitted that its design be a bit more expensive.

A preferred application of the first and second embodiments of the present invention in the field of television image processing is characterized in that said input signal is a Standard Definition Television (SDTV) signal, that said output signal is a High Definition Television (HDTV) signal, that said filter coefficients of the first type implement spatial scaling, that said filter coefficients of the second type implement peaking and/or LTI and that said filter coefficients of the third type implement edge steepness detection.

The present invention also refers to a computer program product directly loadable into the internal memory of a digital computer, comprising software code portions for performing the steps of claim 1 when said product is run on a computer.

These and other aspects of the invention will be apparent from and elucidated with reference to the embodiments described hereinafter. In the figs. show:

FIG. 1 the general structure of a polyphase filter,

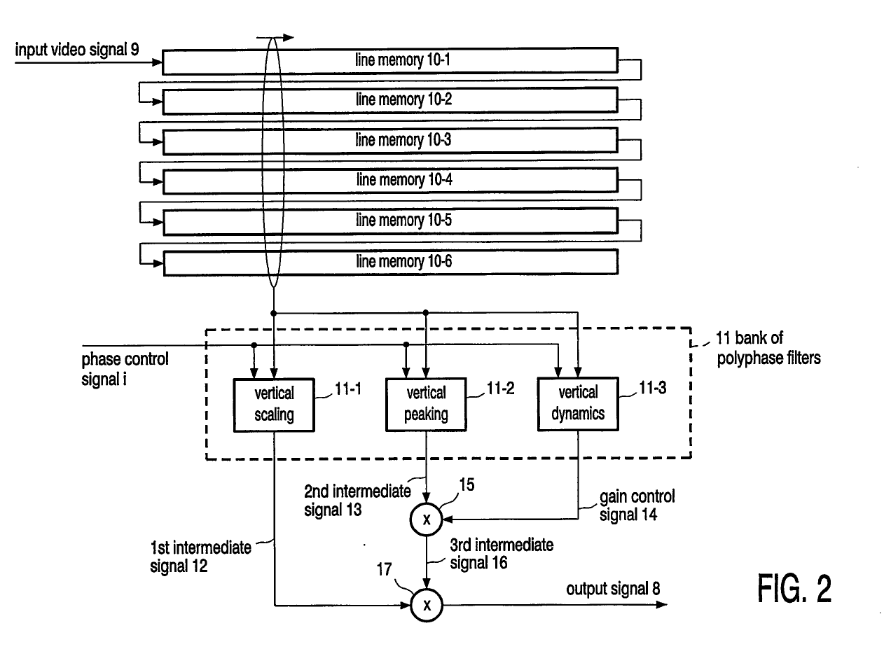

FIG. 2 a schematic representation of the method for combined sampling rate conversion and gain-controlled filtering of a video signal according to the present invention,

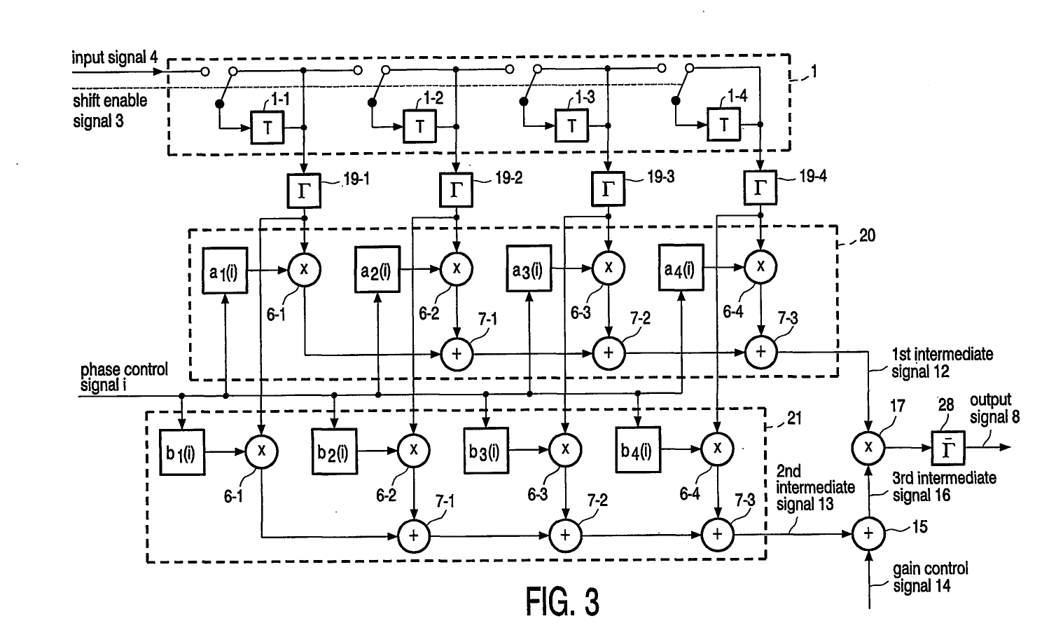

FIG. 3 a first embodiment of a device for combined sampling rate conversion and gain-controlled filtering of a video signal according to the present invention, and

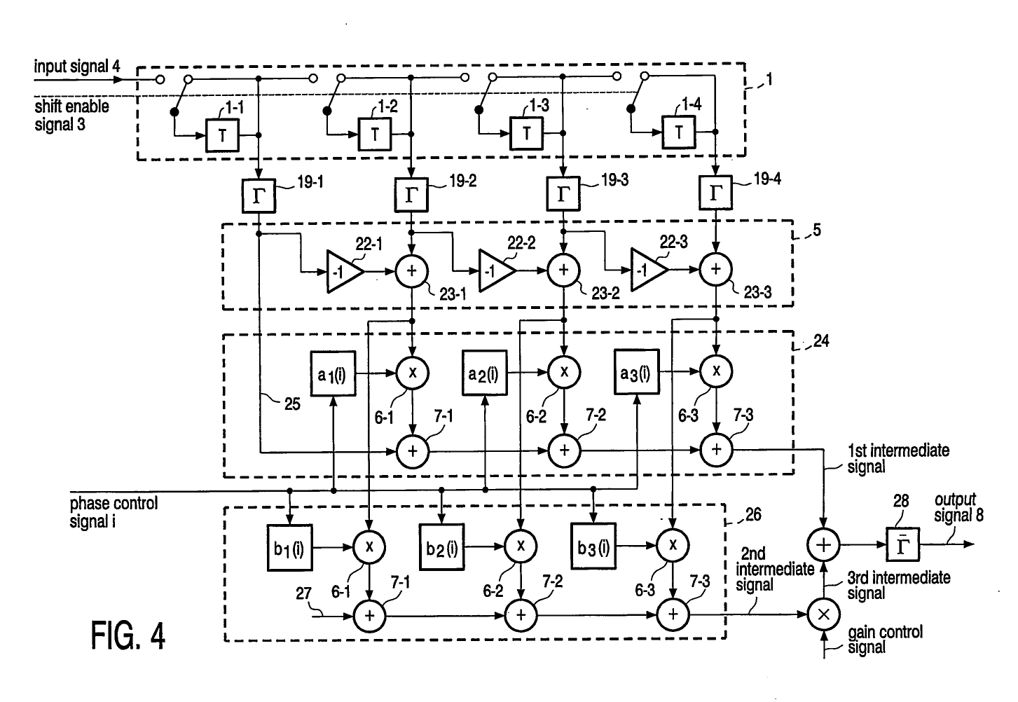

FIG. 4 a second embodiment of a device for combined sampling rate conversion and gain-controlled filtering of a video signal according to the present invention.

Note that in the numbering of the components of different figs., each repeated component always is assigned the same numeral.

FIG. 2 is a schematic presentation of the method for combined sampling rate conversion and gain-controlled filtering of a digital signal, where vertical sampling rate conversion and vertical peaking of the Y (luma) component of a video signal 9 is taken as an example. The set-up of FIG. 2 comprises a multiplicity of line memories 10-1 . . . 10-6 that store several adjacent lines of an input video signal 9 that is composed of lines and columns of picture elements (pixels). Note that, instead of using six line memories as in the present example, depending on the television system, any number of line memories larger than two may be used. Only vertical image processing is considered here, thus only the vertically adjacent pixels of the same columns of the line memories 10-1 . . . 10-6 are subject to sampling rate conversion and peaking. The vertically adjacent pixels stored in the line memories 10-1 . . . 10-6 are then filtered with a bank of polyphase filters 11, comprising three polyphase filters for vertical scaling 11-1, vertical peaking 11-2 and calculation of vertical dynamics 11-3. These polyphase filters produce a first intermediate signal 12, a second intermediate signal 13 and a gain control signal 14, respectively. The second intermediate signal 13 is multiplied with the gain control signal 14 by means of a multiplier instance 15 yielding a third intermediate signal 16, which is added to the first intermediate signal by means of an addition instance 17 to finally produce the scaled and peaked output signal 8.

Combined sampling rate conversion (vertical scaling) and gain-controlled filtering (peaking) is achieved by implementing the first polyphase filter 11-1 as low-pass filter, the second polyphase filter 11-2 as band-pass filter and the third polyphase filter 11-3 as differentiation filter. The first intermediate signal 12 then represents a scaled and low-pass filtered output signal as known from prior art, which lacks high frequencies above the Nyquist limit of the original input signal spectrum. By adding the second intermediate signal 13, which was subject to peaking, to the first intermediate signal 12, at least a boosting of frequency components below the Nyquist limit can be achieved in the sum signal, and thus an artificial improvement of image quality is achieved. With non-linear LTI, even higher harmonics can be created that fill up the empty spectrum of the sum signal. To keep the dynamic gain of the sum signal in technically feasible ranges, and to prevent excessive image clipping and increased noise in the sum signal, the second intermediate signal 13 is multiplied with a gain control signal 14, and the resulting third intermediate signal 16 is added to the first intermediate signal 12. The gain control signal is derived from the vertical image dynamics by implementing the third polyphase filter 11-3 as edge steepness detector. High frequency boosting then takes only place for significant edge amplitudes of the signal to avoid noise enhancement. All three polyphase filters 11-1 . . . 11-3 use the same registers. The filter coefficients of the polyphase filters are defined so that the frequency domain filter characteristics of the polyphase filters are approximately equal for each filtering step within a cycle and that the filter phases cyclically change in response to the phase control signal i, in order to achieve the re-sampling of the vertically adjacent pixels that after all allows for the sampling rate conversion. The shift enable signal 3, which is not depicted in FIG. 2, ensures the proper shifting of the line memories 10-1 . . . 10-6, so that in each filtering step of a cycle, a correct matching of filter coefficients and shift register (line memory) pixel contents is achieved, including the step of not shifting the pixel contents of the line memory in some filtering steps of a cycle to enable up-conversion (increase of the sampling rate). It is a benefit of the parallel implementation of scaling and peaking that the resonant frequency of the peaking polyphase filter can be put on a high frequency in the original image where there is always significant content. This frequency does not depend on the up-conversion ratio. In contrast, if scaling and peaking was performed in a two-step procedure (first scaling and then peaking), the peaking filter had to be adapted to the up-conversion ratio in order to keep enhancing the same original frequencies. As already stated, sharpness by peaking of the up-converted image can only be achieved by enhancing the highest frequencies that the original image contains. However, with a non-linear method like LTI, higher harmonics of such frequencies can be generated in an attempt to fill up the wider spectrum after up-conversion.

FIG. 3 depicts a first preferred embodiment of a device for combined sampling rate conversion and gain-controlled filtering of a video signal according to the present invention. FIG. 3 depicts a shift register 1, which comprises registers 1-1 . . . 1-4 and is operated in response to a shift enable signal 3. An input signal 4, which represents an input video signal composed of pixels, lines and frames of a video stream, is fed into the shift register 1. The shift register 1 thus represents one column of the set of line memories as depicted in FIG. 1. Note that, depending on the television system, any number of registers larger than two may be used in shift register 1 instead of the 4 registers that are depicted in this particular embodiment Further note that the functionality of the shift register 1 is equally well provided by a circular buffer with rotating multiplexer switches or other controllable storage devices.

The output of each register is put through a gamma correction circuit 19-1 . . . 19-4, yielding a gamma-corrected register output signal, and then put into a weighting block 20 that comprises multiplication instances 6-1 . . . 6-4, where each gamma-corrected register output signal is multiplied with a filter coefficient a1(i) . . . a4(i), and where the weighted gamma-corrected register output signals are then added by means of addition instances 7-1 . . . 7-3 to yield the first intermediate signal 12. Taken together, the shift register 1 and the first weighting block 20 represent the first polyphase filter as introduced in FIG. 1. However note that the combination circuit 5 of FIG. 1 is not required here.

A second weighting block 21 with multiplication instances 6-1 . . . 6-4, filter coefficients b1(i) . . . b4(i) and addition instances 7-1 . . . 7-3 is provided that furnishes the second intermediate signal. Taken together, the shift register 1 and the second weighting block 21 represent the second polyphase filter, producing the second intermediate signal 13.

A third polyphase filter, which is not depicted in FIG. 3, consists of a shift register 1 and a third weighting block. This polyphase filter is part of a gain control instance that furnishes the gain control signal 14, which is multiplied with the second intermediate signal 13 to produce the third intermediate signal 16, which in turn is added to the first intermediate signal 12 by means of the addition instance 17. The sum signal is fed into an anti-gamma correction circuit 28 to finally yield the output signal 8. The gain control instance further contains one or more of the following components: an absolute-value circuit, a small look-up table or another non-linear function to reduce the peaking of the steepest edges detected by the polyphase filter, and a coring circuit to reduce the peaking of the noise signals.

The sum of the coefficients a1(i) . . . a4(i) in each cycle now is chosen so that the DC gain is always 1, implementing a low-pass filter. The filter coefficients a1(i) . . . a4(i). for each filtering step of a cycle are taken from a look-up table, with the phase control signal i as index. The sum of the coefficients b1(i) . . . b4(i) in each cycle is chosen so that the DC gain is always zero, implementing a band-pass filter suited for peaking and LTI. Accordingly, the coefficients for implementation of a differentiating filter for the third polyphase filter are stored in a look-up table as well and read out according to the present filtering cycle so as to achieve the proper delay of the input signal.

The gamma correction circuits 19-1 . . . 19-4 allow to perform the vertical scaling and peaking in the linear light domain, reducing vertical aliasing and improving peaking. Calculation of the gain control signal is advantageously performed in the gamma domain. Gamma correction generally increases the word length of the video signal, so that applying the gamma correction before the registers would imply that all registers 1-1 . . . 1-4 must be made wider and thus more expensive. It is assumed that it is cheaper to apply gamma correction multiple times with gamma correction circuits 19-1 . . . 19-4 located after the registers 1-1 . . . 1-4, as it is depicted in FIG. 3, instead of applying gamma correction before the registers 1-1 . . . 1-4. This can only be achieved if cheap approximations of the gamma correction circuits 19-1 . . . 19-4 have been designed. Another benefit of applying gamma correction behind the registers 1-1 . . . 1-4 is that a third polyphase filter for edge detection can advantageously keep working in the gamma domain instead of working in the linear light domain. The anti-gamma correction circuit 28 must implement an exact inverse function of the prior gamma correction circuit 19-1 . . . 19-4, even if that gamma correction circuit is only an approximation. Since anti-gamma correction is applied only once, it is permitted that its design be a bit more expensive.

FIG. 4 shows a second preferred embodiment of a device for combined sampling rate conversion and gain-controlled filtering of a video signal according to the present invention. FIG. 4 depicts a shift register 1, which comprises registers 1-1 . . . 1-4 and is operated in response to a shift enable signal 3. An input signal 4, which represents an input video signal composed of pixels, lines and frames of a video stream, is fed into the shift register 1. The shift register 1 thus represents one column of the set of line memories as depicted in FIG. 1. Note that, depending on the television system, any number of registers larger than two may be used in shift register 1 instead of the 4 registers that are depicted in this particular embodiment. Further note that the functionality of the shift register 1 is equally well provided by a circular buffer with rotating multiplexer switches or other controllable storage devices. The output of each register is put through a gamma correction circuit 19-1 . . . 19-4, yielding a gamma-corrected register output signal. A combination circuit 5 then pair-wise forms the difference of two adjacent gamma-corrected register output signals by means of inverter instances 22-1 . . . 22-3 and addition instances 23-1 . . . 23-3 and puts the resulting difference signals, as well as the unchanged first gamma-corrected register output signal, into a weighting block 24 that comprises multiplication instances 6-1 . . . 6-3, where the difference signals as output by the combination circuit 5 are multiplied with filter coefficients a1(i) . . . a3(i), and where the weighted difference signals and the unchanged first gamma-corrected register output signal are then added by means of addition instances 7-1 . . . 7-3 to yield the first intermediate signal 12. Taken together, the shift register 1 and the first weighting block 24 represent the first polyphase filter as introduced in FIG. 1. Note that within the weighting block 24, the unchanged first gamma-corrected register output signal is not multiplied with a coefficient, but directly added to the sum of weighted difference signals. This path is marked by numeral 25. However, to maintain the formal definition of a polyphase filter as introduced in FIG. 1, this path 25 may equally well be imagined as an weighting block input value that is multiplied with a constant weight a0(i)=1, i=1 . . . N. This unit weight obviously saves one look-up table and one multiplication instance and thus even improves the performance.

Corresponding to the first weighting block 24, a second weighting block 26 with multiplication instances 6-1 . . . 6-4, filter coefficients b1(i) . . . b3(i) and addition instances 7-1 . . . 7-3 is provided. Taken together, the shift register 1 and the second weighting block 26 represent the second polyphase filter, producing the second intermediate signal 13. Note that in the second weighting block 26, the unchanged first gamma-corrected register output value is not added to the sum of the weighted difference signals. The corresponding path is marked with numeral 27 and, in compliance with the definition of a polyphase filter as in FIG. 1, may be interpreted as a weighting block input value that is multiplied with the constant weight b0(i)=0, i=1 . . . N. This zero weight obviously saves one look-up table, one multiplication instance and one addition instance, and thus even improves the performance, because the DC gain is guaranteed to be zero.

A third polyphase filter, which is not depicted in FIG. 4, consists of a shift register 1 and a third weighting block. This polyphase filter is part of a gain control instance that furnishes the gain control signal 14, which is multiplied with the second intermediate signal 13 to produce the third intermediate signal 16, which in turn is added to the first intermediate signal 12 by means of the addition instance 17. The sum signal is then fed into an anti-gamma correction circuit 28 to finally yield the output signal 8. The gain control instance further contains one or more of the following components: an absolute-value circuit, a small look-up table or another non-linear function to reduce the peaking of the steepest edges detected by the polyphase filter, and a coring circuit to reduce the peaking of the noise signals.

The path 25 within the first weighting block 24 represents a DC path, whereas the multiplication instances 6-1 . . . 6-3 operate on the pair-wise difference signals out of the adjacent gamma-corrected register output signals, which represent AC signals. By adding the signal of the DC path 25 to the weighted signals, a low-pass filter is realized.

The filter coefficients a1(i) . . . a3(i) for each filtering step of a cycle are taken from a look-up table, with the phase control signal i as index.

In the second weighting block, no DC path is present, and the multiplication instances 6-1 . . . 6-3 operate on the pair-wise difference signals out of the adjacent gamma-corrected register output signals, which represent only AC signals. Thus the filter characteristic of the second polyphase filter becomes a band-pass characteristic with zero DC gain, suited for peaking and LTI. The filter coefficients b1(i) . . . b3(i) for each filtering step of a cycle are taken from a look-up table as well, with the phase control signal i as index.

Accordingly, the coefficients for implementation of a differentiating filter for the third polyphase filter are stored in a look-up table as well and read out according to the present filtering cycle so as to achieve the proper delay of the input signal.

The gamma correction circuits 19-1 . . . 19-4 allow to perform the vertical scaling and peaking in the linear light domain, reducing vertical aliasing and improving peaking. Calculation of the gain control signal is advantageously performed in the gamma domain. Gamma correction generally increases the word length of the video signal, so that applying the gamma correction before the registers would imply that all registers 1-1 . . . 1-4 must be made wider and thus more expensive. It is assumed that it is cheaper to apply gamma correction multiple times with gamma correction circuits 19-1 . . . 19-4 located after the registers 1-1 . . . 1-4, as it is depicted in FIG. 4, instead of applying gamma correction before the registers 1-1 . . . 1-4. This can only be achieved if cheap approximations of the gamma correction circuits 19-1 . . . 19-4 have been designed. Another benefit of applying gamma correction behind the registers 1-1 . . . 1-4 is that a third polyphase filter for edge detection can advantageously keep working in the gamma domain instead of working in the linear light domain. The anti-gamma correction circuit 28 must implement an exact inverse function of the prior gamma correction circuit 19-1 . . . 19-4, even if that gamma correction circuit is only an approximation. Since anti-gamma correction is applied only once, it is permitted that its design be a bit more expensive.

1. Method for combined sampling rate conversion and gain-controlled filtering of a digital signal, where an input signal is converted into a filtered output signal, comprising the steps of:
filtering the input signal with a first polyphase filter yielding a first intermediate signal,
filtering the input signal with a second polyphase filter yielding a second intermediate signal,
multiplying said second intermediate signal with a gain control signal yielding a third intermediate signal, and
adding said third intermediate signal to said first intermediate signal yielding said output signal.

2. Method according to claim 1, characterized in that the first polyphase filter has a low-pass filter characteristic in the frequency domain.

3. Method according to claim 1, characterized in that the second polyphase filter has a band-pass filter characteristic in the frequency domain.

4. Method according to claim 1, characterized in that the gain control signal is derived from a signal that is generated by filtering the input signal with a third polyphase filter.

5. Method according to claim 4, characterized in that the third polyphase filter is a differentiating filter.

6. Method according to claim 1, characterized in that the filter coefficients for each multiplication tap of the polyphase filters are stored in look-up-tables and are cyclically read out in response to a phase control signal.

7. Method according to claim 1, characterized in that said polyphase filters share the shift register.

8. Method according to claim 1, characterized in that said input signal is a video signal, that said input signal is transformed into the linear light domain by gamma correction before it is filtered with the polyphase filters and that said output signal is transformed back to the gamma domain by anti-gamma correction.

9. Method according to claim 1, characterized in that said input signal is a video signals, that gamma correction is performed for each output value of the registers within at least the first and second polyphase filter and that said output signal is transformed back to the gamma domain by anti-gamma correction.

10. Method according to claim 1, characterized in that
said input signal is a Standard Definition Television (SDTV) signal,
said output signal is a High Definition Television (HDTV) signal,
said first polyphase filter performs spatial scaling,
said second polyphase filter performs peaking and/or LTI; and
that said third polyphase filter performs edge steepness detection.

11. Device for combined sampling rate conversion and gain-controlled filtering of a digital signal, where an input signal is converted into a filtered output signal, comprising:
a shift register comprising a multiplicity of registers that are jointly controlled by a shift enable signal for storing consecutive values of said digital signal,
circuitry for multiplying the output of each register with filter coefficients of a first type and summing the products yielding a first intermediate signal,
circuitry for multiplying the output of each register with filter coefficients of a second type and summing the products yielding a second intermediate signal,
circuitry for multiplying the second intermediate signal with a gain control signal yielding a third intermediate signal,
circuitry for adding the first and third intermediate signals yielding said output signal, and
means to cyclically change the filter coefficients of the first and second type in response to a phase control signal.

12. Device according to claim 11, characterized in that the filter coefficients of the first type are chosen so that the filter DC gain is always one.

13. Device according to claim 11, characterized in that the filter coefficients of the second type are chosen so that the filter DC gain approaches zero.

14. Device according to claim 11, characterized in that the device further comprises circuitry for multiplying the output of each register with filter coefficients of a third type and summing the products yielding a signal that serves as a basis for said gain control signal.

15. Device for combined sampling rate conversion and gain-controlled filtering of a digital signal, where an input signal is converted into a filtered output signal, comprising:
a shift register comprising a multiplicity of registers that are jointly controlled by a shift enable signal for storing consecutive values of said digital signal,
circuitry for forming the differences between the outputs of adjacent registers, for multiplying these differences with filter coefficients of a first type and for summing the products and the output of at least one register yielding a first intermediate signal,
circuitry for multiplying said differences with filter coefficients of a second type and for summing the products yielding a second intermediate signal,
circuitry for multiplying the second intermediate signal with a gain control signal yielding a third intermediate signal,
circuitry for adding the first and third intermediate signals yielding said output signals, and
means to cyclically change the filter coefficients of the first and second type in response to a phase control signal.

16. Device according to claim 15, characterized in that the device further comprises circuitry for multiplying said differences with filter coefficients of a third type and for summing the products yielding a signal that serves as a basis for said gain control signal.

17. Device according to claim 11, characterized in that the device further comprises look-up-tables for generating the filter coefficients of the first and second type in response to a phase control signal.

18. Device according to claim 11, characterized in that the device further comprises one gamma correction circuit for applying gamma correction to said input signal and one anti-gamma correction circuit for applying anti-gamma correction to said output signal.

19. Device according to claim 11, characterized in that the device further comprises multiple gamma correction circuits for applying gamma correction to the outputs of said registers and one anti-gamma correction circuit for applying anti-gamma correction to said output signal.

20. Device according to claim 14 characterized in that
said input signal is a Standard Definition Television (SDTV) signal,
said output signal is a High Definition Television (HDTV) signal,
said filter coefficients of the first type implement spatial scaling,
said filter coefficients of the second type implement peaking and/or LTI and;
that said filter coefficients of the third type implement edge steepness detection.

21. A computer program product directly loadable into the internal memory of a digital computer, comprising software code portions for performing the steps of claim 1 when said product is run on a computer.
